(19) United States
(12) Patent Application Publication
(10) Pub. No.: US 2008/0211971 A1
(43) Pub. Date: Sep. 4, 2008

(54) COLOR BALANCING SYSTEMS AND METHODS

(75) Inventor: Apurba Pradhan, San Francisco, CA (US)

Correspondence Address: SCHWEGMAN, LUNDBERG & WOESSNER, P.A., P.O. BOX 2938, MINNEAPOLIS, MN, 55402, US

(73) Assignee: Luxim Corporation, Sunnyvale, CA (US)

(21) Appl. No.: 11/970,428

(22) Filed: Jan. 7, 2008

Related U.S. Application Data
(60) Provisional application No. 60/879,497, filed on Jan. 8, 2007.

(51) Int. Cl. H04N 9/12

(52) U.S. Cl. 348/743; 348/E09.012

(57) ABSTRACT

A display system is described comprising a light source, color wheel and a light modulator. The light source is configured to emit a beam of white light along a first light path. The color wheel may be provided on a first light path and be configured to filter the beam of white light, the color wheel having a plurality of color segments, including a red color segment, a blue color segment, a green color segment and a magenta color segment. The magenta color segment is the only subtractive primary color segment and has a duty cycle of greater than 0.1. The light modulator may be configured to receive filtered light from the color wheel and modulate the received light to produce an image. The light source may be an electrodeless plasma lamp and the lamp may have a bulb containing a fill that includes Indium Bromide.

### CROSS-REFERENCE TO RELATED APPLICATIONS

This application claims priority to U.S. provisional application Ser. No. 60/879,497, filed Jan. 8, 2007, which is incorporated herein by reference.

### BACKGROUND

I. Field

The field of the present invention relates to color balancing in a display system.

II. Background

In many applications, it is desirable that the white point of a projection system be as close as possible to the blackbody curve. When the intrinsic white point of a display does not fall on a desired location on the blackbody curve, compensation with other components in the system is termed “color balancing.”

What is desired are improved systems and methods for color balancing.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A schematically depicts a micro-display projection system according to an example embodiment utilizing a light source, color wheel, a collection optics assembly, matching optics assembly, micro-display imager, system control electronics, projection optics assembly, and screen.

FIG. 1B is a functional block diagram of a FIG. 1A projection system utilizing a single color wheel, matching optics assembly, and micro-display imager, according to an example embodiment.

FIGS. 2A and 2B each show an example color wheel according to an example embodiment.

FIG. 3 shows the spectrum of an example light source.

FIG. 4 shows the 1931-CIE color gamut chart and the blackbody curve on the standard x/y chromaticity coordinate plane.

FIG. 5A shows the transmission spectrum of an example RGBM color wheel.

FIG. 5B shows example embodiments of an RGBM color wheel on the 1931-CIE chromaticity chart and associated white points.

FIG. 5C shows example embodiments of an RGBM color wheel on the 1931-CIE chromaticity chart and associated white points.

FIG. 6A shows an example embodiment of an RGB color wheel on the 1931-CIE chromaticity chart and its associated white point.

FIG. 6B shows the transmission spectrum of the RGB color wheel depicted in FIG. 6A.

FIG. 7 shows the spectrum of an example light source.

FIG. 8 shows an example color wheel layout.

FIG. 9A shows the transmission spectrum of an example RGBCYM color wheel.

FIG. 9B shows the transmission spectrum of an example RGBCYM color wheel.

FIG. 10A shows an example RGBCYM color wheel on the 1931-CIE chromaticity chart and associated white point.

FIG. 10B shows an example RGBCYM color wheel on the 1931-CIE chromaticity chart and associated white point.

FIG. 11 is a cross-section and schematic view of an example electrodeless plasma lamp that may be used as a light source in a projection system according to an example embodiment.

FIG. 12 is a cross-section and schematic view of an example electrodeless plasma lamp that may be used as a light source in a projection system according to an example embodiment.

### DESCRIPTION OF EXAMPLE EMBODIMENTS

While the present invention is open to various modifications and alternative constructions, the embodiments shown in the drawings will be described by way of example herein in detail. It is to be understood, however, there is no intention to limit the invention to the particular forms disclosed. On the contrary, it is intended that the invention cover all modifications, equivalences and alternative constructions falling within the spirit and scope of the invention as expressed in the appended claims.

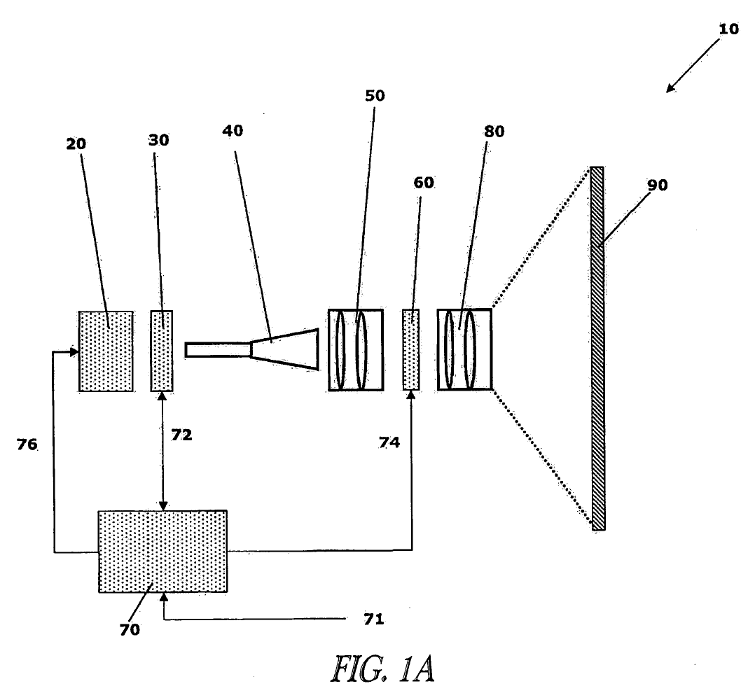

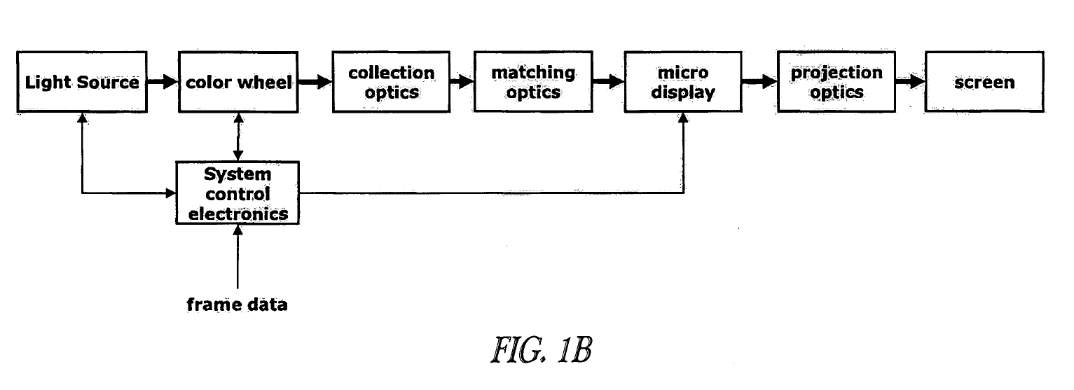

Referring to FIG. 1A, an example micro-display projection system 10 includes a light source 20, color wheel 30, collection optics assembly 40, matching optics assembly 50, micro-display imager 60, system control electronics (SCE) 70, projection optics assembly 80, and screen 90. Light source 20 may be an electrodeless plasma lamp that emits broad-spectrum white light to color wheel 30 which may be divided into red-, green- and blue- and magenta-filter sectors. Other color segments may also be used, such as Cyan and Yellow as described further below. Some color wheels may also include other color segments, such as a clear (white transmissive) color segment, and other types of color filters may be used in other embodiments. Typically, color wheel 30 is driven at a preselected rotation rate (e.g., about 120 or 240 rotations per second in some embodiments) by the system control electronics 70; its rotational phase (angular position) is fed back via two-way link 72. In this example, rapidly alternating primary-color light exiting the color wheel reaches micro-display imager 60 after passing through matching optics assembly 50. In this example embodiment, the system control electronics 70 performs the function of translating the frame data encoding the image to be projected into detailed commands for the micro-display imager 60. For each color primary (e.g., R, G, B or M) a set of pixel elements on the micro-display imager 60 is commanded by the system control electronics 70 via a one-way link 74 to spatially modulate that color, forming a pattern that is the monochromatic primary component of the image being displayed. Algorithms executed by the SCE 70 for generating the desired color for a pixel from primary components include, for example, BrilliantColor™ from Texas Instruments. In some example embodiments, the transitional portion or spoke between adjacent colors on the color wheel may be processed as secondary color elements to boost brightness.

In this example embodiment, each pattern consists of a two-dimensional array of sub-pixels for each color, of varying intensity. The micro-display imager 60 may selectively control the light projected to the screen 90 for each sub-pixel. With some micro-display imagers 60, the light may be selectively transmitted through the micro-display imager to the screen 90 (as suggested by the arrangement shown in FIG. 1). Other micro-display imagers 60 may selectively reflect light to the screen 90.

One type of micro-display imager that may be used in example embodiments is a DLP® microdisplay. DLP® microdsplays use a grid of micromirrors to selectively reflect light to the screen 90. These micromirrors form the pixel elements of the microdisplay. In example embodiments, there may be one mirror for each pixel location and each mirror can be tilted very rapidly. Tilting one way allows light to reflect toward the screen, while tilting another way allows the light to be reflected such that the light does not reach the screen. The color shade of each pixel is controlled through a dithering technique that varies the amount of time each pixel reflects light to the screen. In a DLP®-based projection system, intensity typically is controlled using pulse-width modulation (PWM) which achieves proportional modulation of the intensity of any particular pixel by controlling, for each displayed frame, the fraction of time spent in either the “ON” or “OFF” state. That is, modulation of the pixels is quantized, and the “ON/OFF” time ratio of each pixel is varied for each color segment of the color wheel, creating the perception of continuous intensity variation when integrated by an observer's much slower visual response. The ON and OFF states correspond to deflections of micro-mirrors forming the pixels, directing light toward or away from, respectively, the projection optical-axis. The modulation waveform on each pixel is typically limited in duration by two factors. At the short extreme is the response time of the micro-mirror; at the long extreme is the refresh rate of the displayed image. The PWM signal typically is a digitally synthesized pulse spanning a preselected range between these two limits, thereby defining a quantized set of achievable intensity modulation points for a given light brightness impinging on the DLP imager. As the color wheel rotates, the micromirror pixel elements sequentially reflect a set of pixels (one for each color segment) to the screen, with the intensity of each pixel element controlled by PWM. Although they are projected sequentially as the color wheel rotates, the sets of pixels for each color segment appear as a single combined image projected on the screen.

In an example embodiment, the amount of PWM for each color segment is controlled by the number of bits used for that color segment. These bits are provided to the system control electronics 70 via input 71 or may be generated by the system control electronics 70 based on other inputs. The system control electronics 70 determines the rotational phase of the color wheel and desired PWM for the corresponding color segment (based on the desired color of the pixel) and controls the micro-display imager 60 via link 74 to provide the appropriate PWM for the color segment. For example, the primary color segment for each pixel may have an 8 bit value, providing for 256 values (e.g., 0-255) for the PWM for that color segment. In example embodiments, each primary color segment has the same number of bits (and corresponding levels of PWM). In other examples, the number of bits may be different for different color segments and may depend on the size of the color segment. Smaller color segments may not be able to accommodate as many levels of PWM. In some embodiments, spokes or small color boost segments are processed with a smaller number of bits.

In other types of micro-display imagers that may be used in example embodiments, e.g., liquid crystal display (LCD) spatial-light modulators, the ON and OFF states of the pixel elements correspond, respectively, to states of high and low optical transmission through the imager. In this example embodiment, a single primary-color sub-image is projected onto a screen after passing through appropriate projection optics. In example projection system 10, these are screen 90 and projection optics assembly 80.

Another type of micro-display imager that may be used in example embodiments is liquid crystal on silicon (LCOS). LCOS microdisplays create pixels by covering a reflective silicon chip with crystal material arranged in a grid pattern. Like LCDs, the orientation of the crystals is controlled by applying current to control the amount of light that is reflected from the chip's surface at each pixel location. This controls the ON and OFF states of the pixel elements. The reflected light is then magnified and focused on the inside surface of the screen 90 to form the picture.

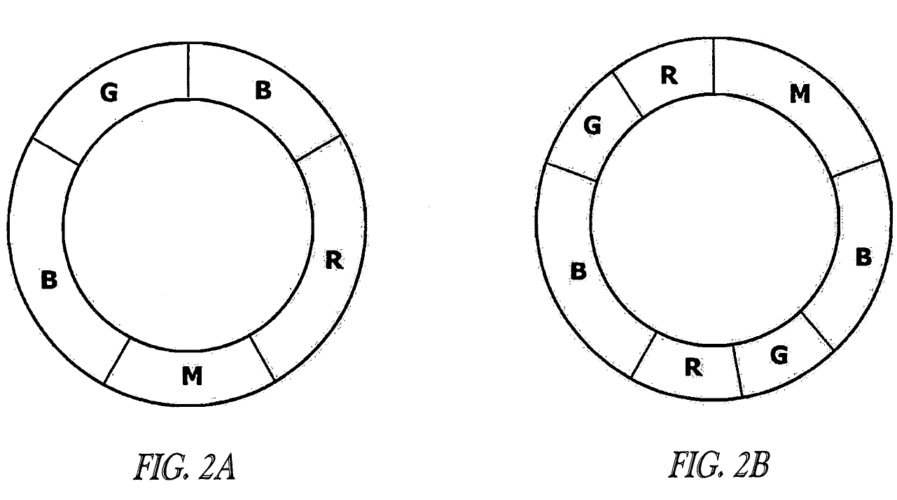

In some example embodiments, a color wheel or other color filter is used with red, green and blue segments as well as an additional magenta segment. FIGS. 2A and 2B each show an example red, blue, green and magenta color wheel that may be used in example embodiments of a projection display system. Red, green and blue are referred to as additive primaries. Cyan, yellow and magenta are referred to as subtractive primaries. In the example color wheels of FIGS. 2A and 2B, the magenta color segment is the only subtractive primary. The color wheels do not include Cyan or Yellow color segments. FIG. 2A shows a color wheel with two blue segments and one segment each of red, green and magenta. Blue is the largest portion of the color wheel and is separate into two segments. FIG. 2B shows a color wheel with two segments each of red, blue and green and one segment of magenta. Once again, blue is the largest portion of the color wheel. In other examples, the color wheel (or other color filter) may consist of different sequences of R,G,B,M segments—for example, RGBM, RBGBM, RGBMRGB, etc. Those skilled in the art will recognize that the design factors involved are the desire to minimize color breakup and the need to maintain the minimum color segment size consistent with the micro-display control's quantization.

While spokes could be processed as additional secondary color elements (or small color boost segments could be added to the color wheel) with one or a few bits of PWM, in the examples of FIGS. 2A and 2B, the magenta segment is similarly sized to the additive primary segments and may be processed using the same number of bits (and levels of PWM) as some or all of the additive primary color segments. As a result, the magenta segment may be treated by the system control electronics as a fully primary color segment for color balancing (e.g., with full bit depth). For example, 8 bits (256 values) of PWM modulation may be used for the magenta segment in this example. In some examples, the magenta segment is sized to be large enough for the full range of PWM to be used for the magenta color segment as for the red, green and blue color segments. In some examples, the magenta segment may be 35, 40, 50 or 60 degrees or more of the 360 degree color wheel. In some examples, the duty cycle of the magenta color segment may be from about 0.1 to 0.2 or any range subsumed therein. In some examples, the magenta segment may not be the smallest color segment and at least one additive primary segment may be smaller than the magenta color segment (e.g., the green segment in FIG. 2B).

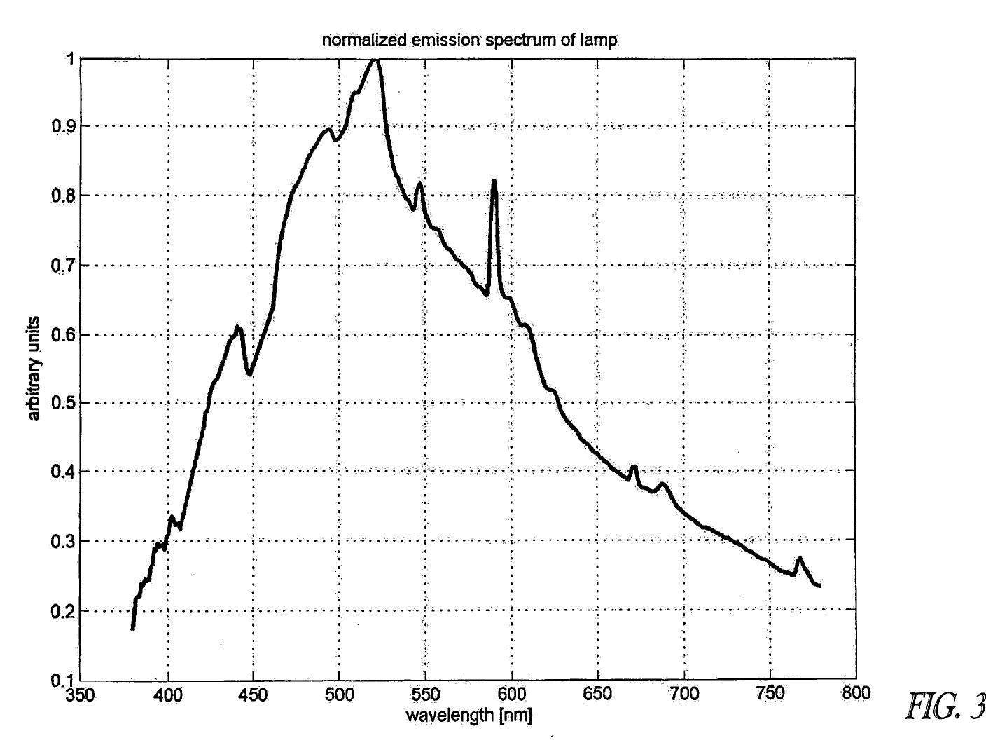

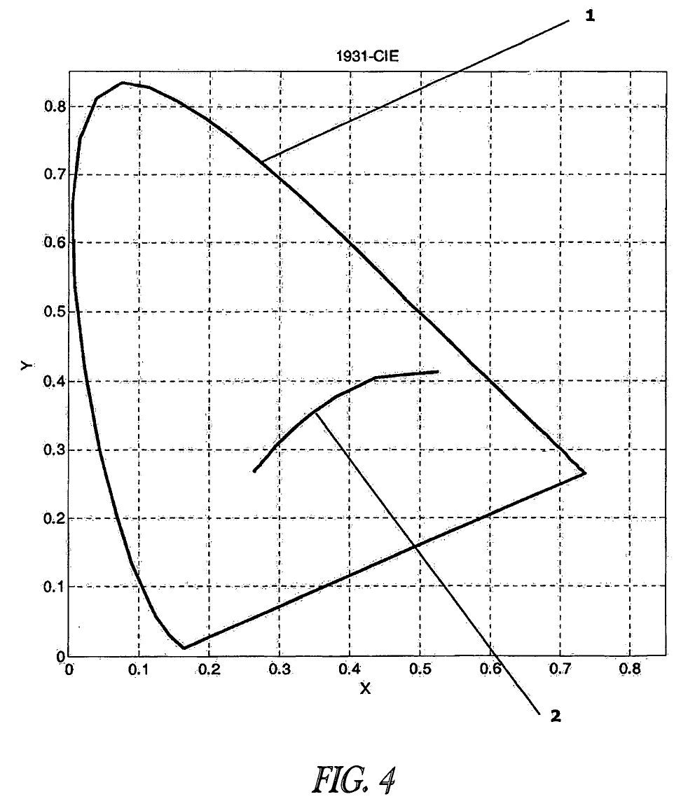

FIG. 3 shows an example spectrum for a light source used in a projection display system according to an example embodiment. This spectrum peaks in green (approx 500 nm). A green-peaked spectrum is typical of many metal-halide high intensity discharge lamps, such as an electrodeless plasma lamp using an Indium Bromide fill as the light emitter. Color wheels of the type shown in FIGS. 2A and 2B may be well-suited for color balancing a light source of this type. Magenta is transmissive to red and blue (subtractive to green). The magenta color segment helps compensate for the lower levels of blue and red in the spectrum, while allowing for higher overall brightness compared to a color balanced RGB color wheel. The large blue segments also help compensate for the lower levels of blue in the spectrum.

To demonstrate the operating principle behind the color-balancing efficiency of these example embodiments, it is helpful to review the fundamentals of chromaticity diagrams. A “color” may be defined by its full spectrum—that is, intensity as a function of wavelength λ. The spectral representation is difficult to work with directly when considering the span of all colors available to a system, with each possible color represented by a full 2-D graph. Instead, it is helpful to reduce any given spectrum to a pair of coordinates on a plane. An infinite set of possible such representations exist, but the accepted standard is the 1931-CIE chromaticity diagram, which specifies three standard spectra: X_{CIE}(λ), Y_{CIE}(λ), Z_{CIE}(λ), fundamentally arbitrary but loosely corresponding to red, green, and blue colors of moderate saturation. Given any arbitrary spectrum f(λ), the prescription to arrive at the corresponding color coordinates (x_{f}, y_{f}) is to compute the vector V(f(λ)):

$$\underline{V} ( f ( λ ) ) = [ \begin{matrix}{\int }_{λ} f ( λ ) {X}_{CIE} ( λ ) d λ \\ {\int }_{λ} f ( λ ) {Y}_{CIE} ( λ ) d λ \\ {\int }_{λ} f ( λ ) {Z}_{CIE} ( λ ) d λ\end{matrix} ]$$

then form the coordinates from the dot product ratios:

$${x}_{f} = \frac{[ \begin{matrix}1 & 0 & 0\end{matrix} ] \underline{V} ( f ( λ ) )}{[ \begin{matrix}1 & 1 & 1\end{matrix} ] \underline{V} ( f ( λ ) )}$$

$${y}_{f} = \frac{[ \begin{matrix}0 & 1 & 0\end{matrix} ] \underline{V} ( f ( λ ) )}{[ \begin{matrix}1 & 1 & 1\end{matrix} ] \underline{V} ( f ( λ ) )}$$

(The corresponding z_{f} is redundant from the relation z_{f}=1−x_{f}−y_{f} and reflects the fact that brightness is normalized on the plane.)

FIG. 4 shows two features represented on the 1931-CIE diagram of relevance to example embodiments. When f(λ) is monochromatic (the Dirac-delta function δ(λ)), the truncated oval 1 is traced out. For λ spanning the entire visible wavelength range (typically taken to be 400-700 nm), this figure bounds all possible colors that can exist on the x/y plane. When f(λ) is the blackbody spectrum representing emission from an ideal blackbody at some temperature T, the arc 2 is traced out. The span shown here corresponds roughly to the temperature span 1500K to 10000K. Because the standard 1931-CIE spectras X_{CIE}(λ), Y_{CIE}(λ); Z_{CIE}(λ) tail-off to zero past 700 nm, blackbody temperatures much higher than 10000K are not usefully depicted—they mathematically collapse to a small arc segment near coordinates (0.25, 0.25).

The following describes an example approach for color balancing using a red, blue, green and magenta color wheel according to example embodiments. Define the spectrum of the lamp to be the function S(λ). Further, define the fractional duty-cycle of the color wheel segments to be T_{R}, T_{G}, T_{B}, T_{M} for red, green, blue, and magenta segments respectively. Note the (typically small) absorption of each of the dichroic filters in the color segments is intentionally not accounted for in this example for simplicity, although other embodiments may take this into account. Therefore in an RGB wheel, T_{R}+T_{G}+T_{B}=1, while in the RGBM wheel, T_{R}+T_{G}+T_{B}+T_{M}=1. Finally, define the actual transmission spectra of the color wheel segments to be R(λ), G(λ), B(λ), and M(λ) for red, green, blue, and magenta segments respectively. For simplicity of discussion, assume that all elements of the projection system are color neutral except for the lamp and the color-wheel (this is largely true in reality). The system white spectrum can be defined as the spectrum that results when the micro-display is commanded to transmit/reflect all the light available from each primary. The system white point is then the (x, y) coordinates of the system white spectrum. Additionally, we can define the total light transmission through the color wheel to be the total area under the white spectrum. We therefore have, for an RGB and RGBM system using the same lamp, the following definitions for the white spectrum and total transmission:

$${W}_{RGB} ( λ ) = S ( λ ) [ {T}_{R} R ( λ ) + {T}_{G} G ( λ ) + {T}_{B} B ( λ ) ]$$

$${B}_{RGB} = {\int }_{λ} {W}_{RGB} ( λ ) d λ$$

$${W}_{RGBM} ( λ ) = S ( λ ) [ {T}_{R} R ( λ ) + {T}_{G} G ( λ ) + {T}_{B} B ( λ ) + {T}_{M} M ( λ ) ]$$

$${B}_{RGBM} = {\int }_{λ} {W}_{RGBM} ( λ ) d λ$$

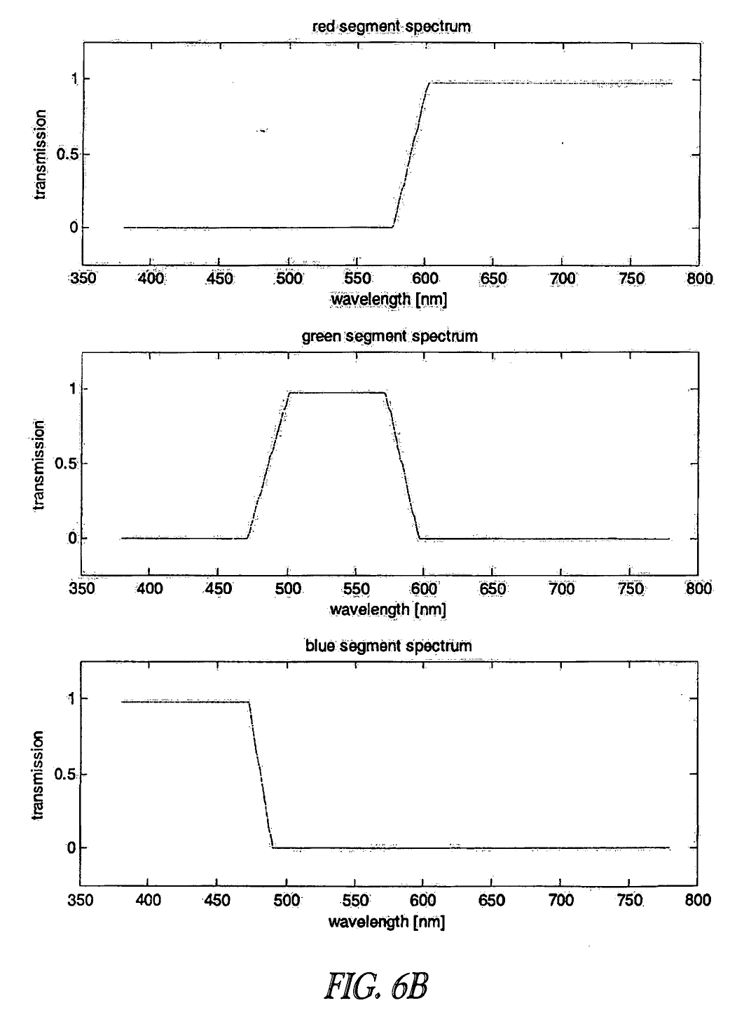

The process of color balancing to a specific white-point temperature with the color wheel is then seen to be more precisely defined as selecting [T_{R}, T_{G}, T_{B}] or [T_{R}, T_{G}, T_{B}, T_{M}] such that the corresponding W_{RGB}(λ) or W_{RGBM}(λ) have (x,y) coordinates that fall on or as close to as possible the blackbody curve at that temperature. In example embodiments, for green-rich S(λ) similar to that of FIG. 3, and color-balance temperatures useful for projection displays (6000-10000K), when [T_{R}, T_{G}, T_{B}] and [T_{R}, T_{G}, T_{B}, T_{M}] have been selected for color balance, B_{RGBM}>B_{RGB}. That is, the color-balanced RGBM lamp/color-wheel system is brighter than the color-balanced RGB system. In fact, we find that, for the typical lamp spectrum shown in FIG. 3, imposing a practical minimum on T_{G} may renders coloring balancing to the blackbody curve unachievable as described further in connection with FIG. 6A below.

FIG. 6A shows an example design of an RBG color wheel on the 1931-CIE chromaticity plane. The spectra of each color segment in this design is shown in FIG. 6B. Corresponding to each of the color segment spectra are the (x/y) coordinates in FIG. 6A; the red segment at 1, blue at 2, and green at 3. In addition, the green segment size conforms to the minimum-segment constraint imposed by an example microdisplay imager PWM algorithm, which in this example is approximately 40 degrees at 14440 RPM wheel rotation speed. Perfect color-balancing at 9000K is not achieved in this example. To come as close as possible to the 9000K blackbody point, the wheel segment duty cycles are [T_{R}, T_{G}, T_{B}]=[0.29, 0.29, 0.42]. The resulting white point is shown on FIG. 6A at 4.

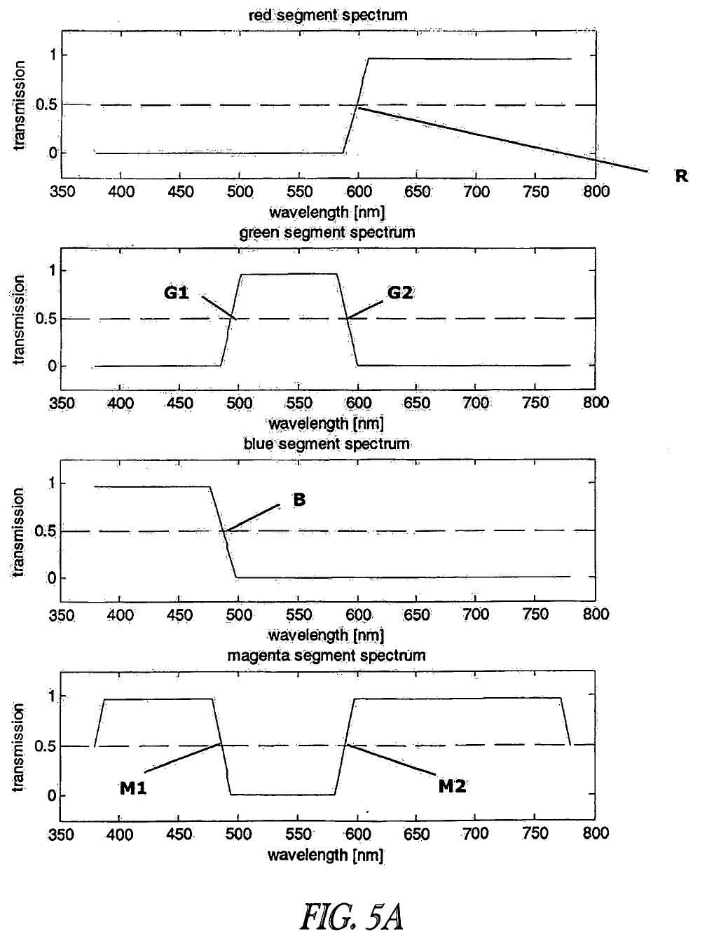

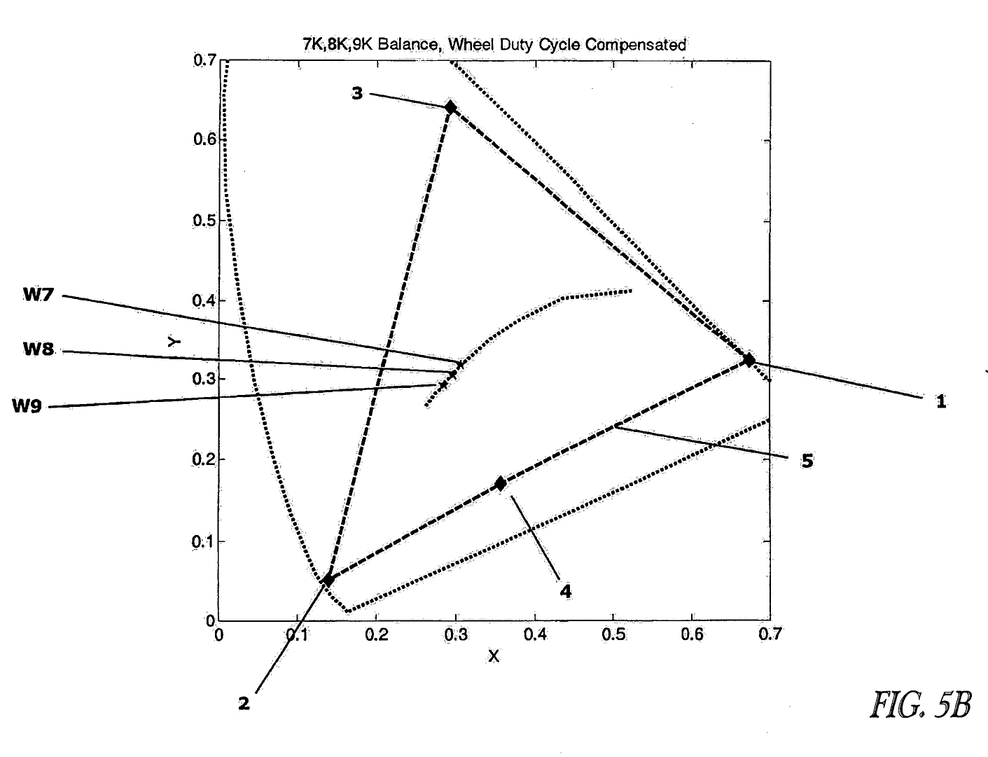

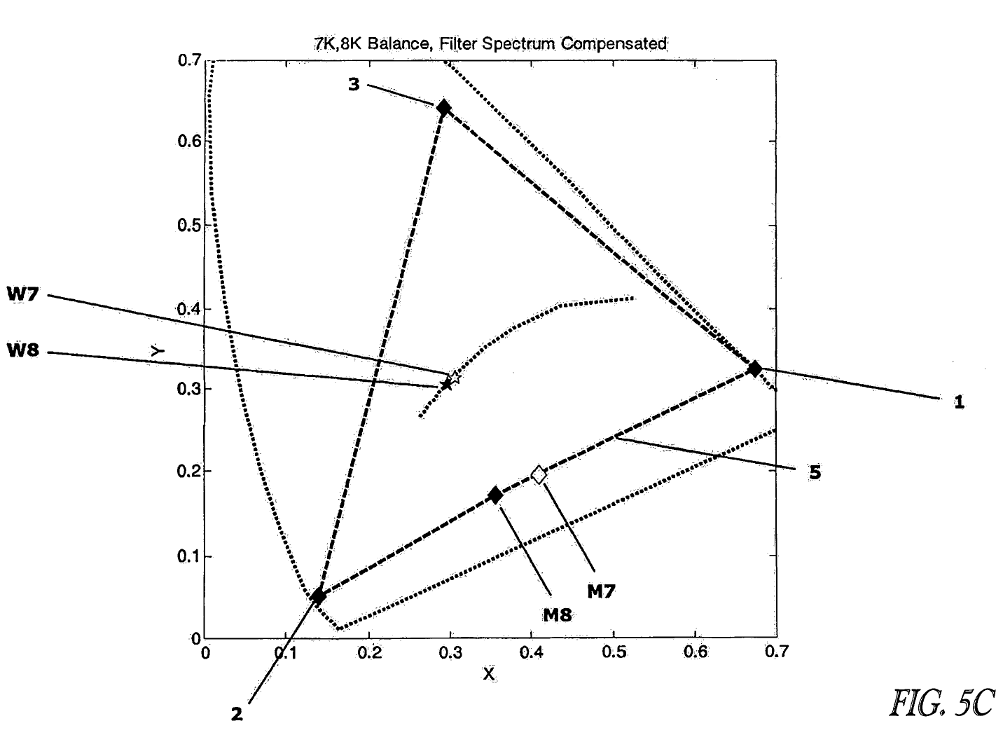

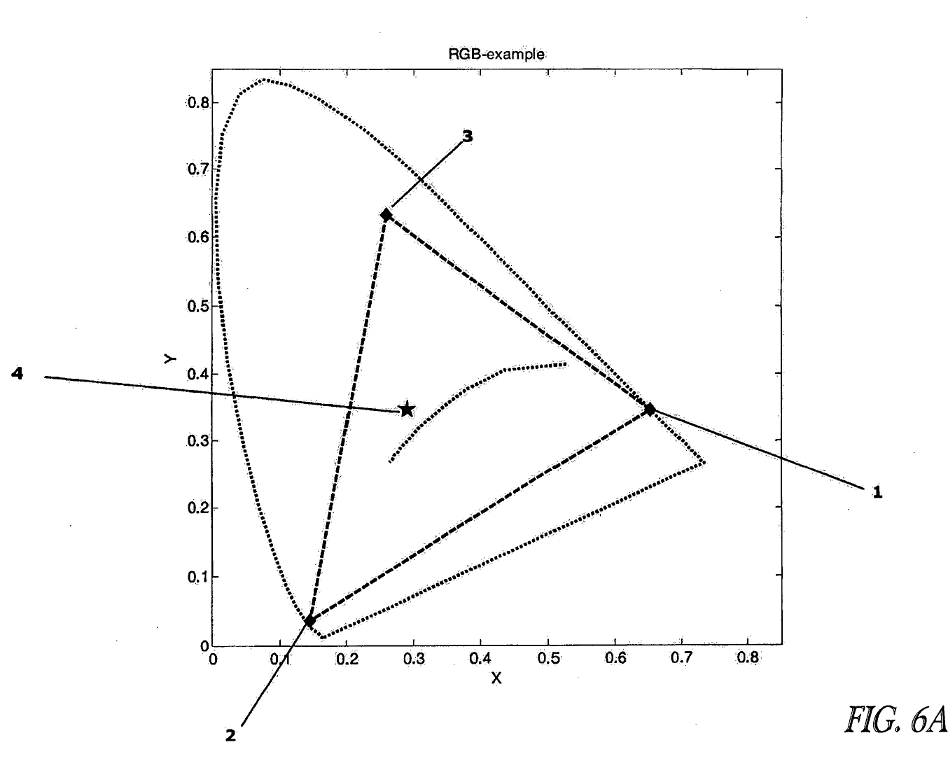

FIG. 5A shows an example design of an RBGM color wheel according to an example embodiment, with the spectra of each color segment plotted vs. wavelength. Corresponding to each of the color segment spectra are the (x/y) coordinates in FIG. 5B; the red segment at 1, blue at 2, green at 3, and magenta at 4. It is a useful property of the chromaticity diagram that the polygon formed by the color segment points 5 bounds all colors achievable with that color wheel.

The spectra in FIG. 5A can be characterized as well by their 50% transmission wavelengths, shown as indices R, G1, G2, B, M1, and M2 for the red, green, blue, and magenta segments respectively. In this example, the indices show wavelengths of 598 nm, 493 nm, 591 nm, 487 nm, 486 nm, and 589 nm respectively. In this example, the slope of each transition is such that minimum and maximum transmissions are spaced apart by no more than about 15 nm. This parameter may be varied in other embodiments, and its value may be selected in a tradeoff against the cost of manufacture.

One example method for achieving color balance is to vary the duty cycle (and therefore the fractional transmission) of each color segment. For the color wheel spectra shown in FIG. 5A and corresponding vertices in FIG. 5B, the points W7, W8, and W9 are white balance points at 7000K, 8000K, and 9000K respectively. The corresponding duty cycles for each color wheel are [T_{R}, T_{G}, T_{B}, T_{M}]=[0.306 0.25 0.333 0.111], [T_{R}, T_{G}, T_{B}, T_{M}]=[0.25 0.25 0.356 0.144], and [T_{R}, T_{G}, T_{B}, T_{M}]=[0.194 0.25 0.389 0.167] respectively. In this example, each segment size is greater than the minimum-segment constraint imposed by an example microdisplay imager PWM algorithm, which in this example is approximately 40 degrees at 14440 RPM wheel rotation speed. It is seen that the magenta wheel segment at 4 in FIG. 5B, when used as a full color primary in conjunction with the projection system, is effective at balancing the white point onto the blackbody curve at a range of temperatures.

In example embodiments, an RGBM color wheel is used to balance a spectrum that peaks in green at a correlated color temperature (CCT) in the range of about 6000-11000K or any range subsumed therein. In example embodiments, the duty cycle for red is in the range of about 0.15 to 0.35 or any range subsumed therein, the duty cycle for green is in the range of about 0.2 to 0.3 or any range subsumed therein, the duty cycle for blue is in the range of about 0.3 to 0.4 or any range subsumed therein and the duty cycle for magenta is in the range of about 0.1 to 0.2 or any range subsumed therein. In example embodiments, the red segment comprises an angle on the color wheel of between about 50 to 120 degrees or any range subsumed therein (which may be a single segment or split among multiple segments), the green segment comprises an angle on the color wheel of between about 60 to 110 degrees or any range subsumed therein (which may be a single segment or split among multiple segments), the blue segment comprises an angle on the color wheel of between about 105 to 150 degrees or any range subsumed therein (which may be a single segment or split among multiple segments) and the magenta segment comprises an angle on the color wheel of between about 35 to 80 degrees or any range subsumed therein (which may be a single segment or split among multiple segments). In some examples, each R, G, B and M color segment is at least 40 degrees. In some examples, the magenta color segment is the only subtractive primary on the color filter or is the only subtractive primary with full bit depth for PWM (e.g., 8 bits or more). In example embodiments, the magenta color segment has 256 or more PWM values. In other examples, the number of PWM values for the magenta color segment is in the range of about 128 to 1024 or any range subsumed therein. In example embodiments, the magenta color segment has the same number of bits (and levels of PWM) as the red color segment, green color segment or blue color segment. In some examples, the red, green, blue and magenta color segments each have a number of PWM values in the range of about 128 to 1024 or any range subsumed therein.

Another example method of achieving color balance is to vary the transmission spectra of the segments on the color wheel. We show an example in FIG. 5C of adjusting the magenta segment spectrum, although in general all segments can be adjusted. Like indices refer to like elements in FIG. 5B. The white point on the blackbody curve at 7000K, as indicated by W7 in FIG. 5C, corresponds to a magenta spectrum whose 50% transmission points are at 470 nm and 585 nm, referring respectively to M1 and M2 in FIG. 5A and indicated at M7 in FIG. 5C. The white point on the blackbody curve at 8000K, as indicated by W8 in FIG. 5C, corresponds to a magenta spectrum whose 50% transmission points are at 486 n m and 589 nm, referring respectively to M1 and M2 in FIG. 5A and indicated at M8 in FIG. 5C.

In example embodiments, an RGBM color wheel is used to balance a spectrum that peaks in green at a correlated color temperature (CCT) in the range of about 6000-11000K or any range subsumed therein. In example embodiments, the 50% transmission points of a magenta color filter segment are, at the low end, in the range of about 450 nm to 510 nm or any range subsumed therein and, at the high end, in the range of about 550 nm to 625 nm or any range subsumed therein. In some embodiments, a color wheel with 50% transmission points in any of the above ranges may be combined with duty cycles for red, green, blue and magenta in any of the ranges described above to achieve color balancing at a desired correlated color temperature (CCT) in the range of about 6000-11000K or any range subsumed therein. These are examples only and other 50% transmission points and duty cycles may be used in other embodiments.

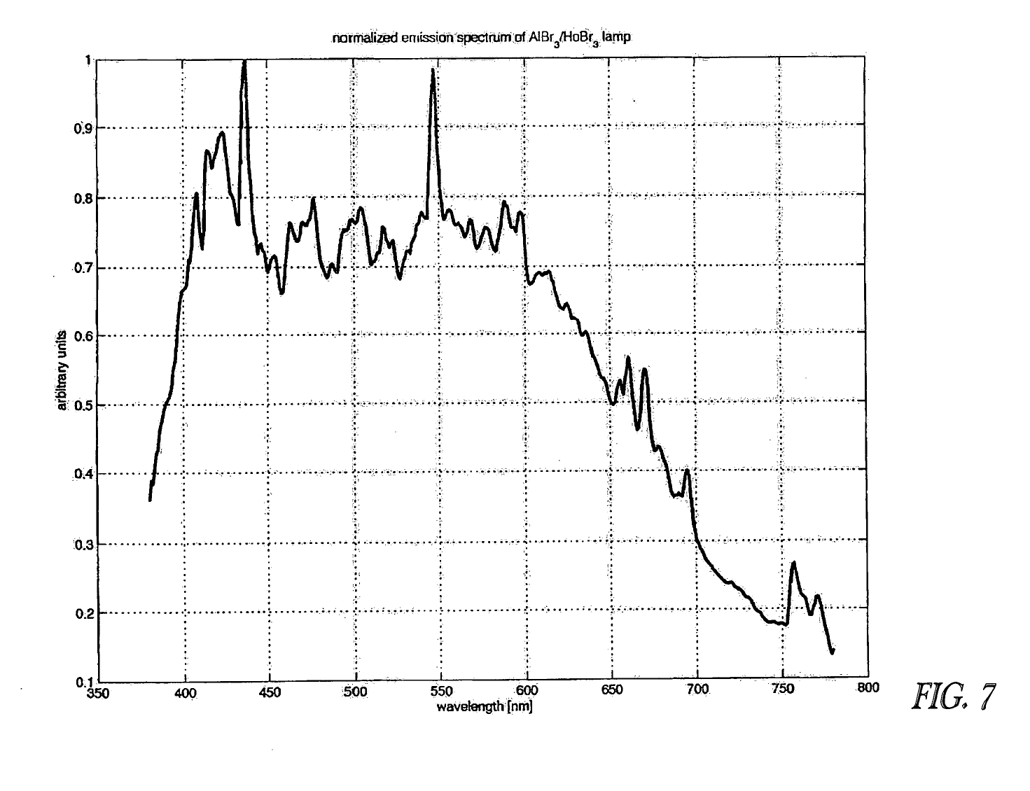

The use of RGBM wheel segments is useful for the plasma emission spectrum shown in FIG. 3, which is typical of a bulb fill material comprising InBr or other Indium halide. The use of RGBM wheel segments is also useful for other metal halide emitters or other fills producing a green rich spectrum. Another useful fill material in high intensity discharge lamps (including, for example, electrodeless plasma lamps) comprises aluminum halide and holmium halide. An example is Aluminum Bromide and Holmium Bromide (AlBr₃/HoBr₃). An example emission spectrum for this fill is shown in FIG. 7. Because this spectrum is flatter in the shorter wavelengths, a full RGBCYM color wheel is more effective in achieving color-balancing onto the blackbody curve. These examples may also be useful with other metal halide fills that include a combination of metal halides that provide more blue (such as AlBr₃) and more red (such as HoBr₃). Additional fills of this type are described further below.

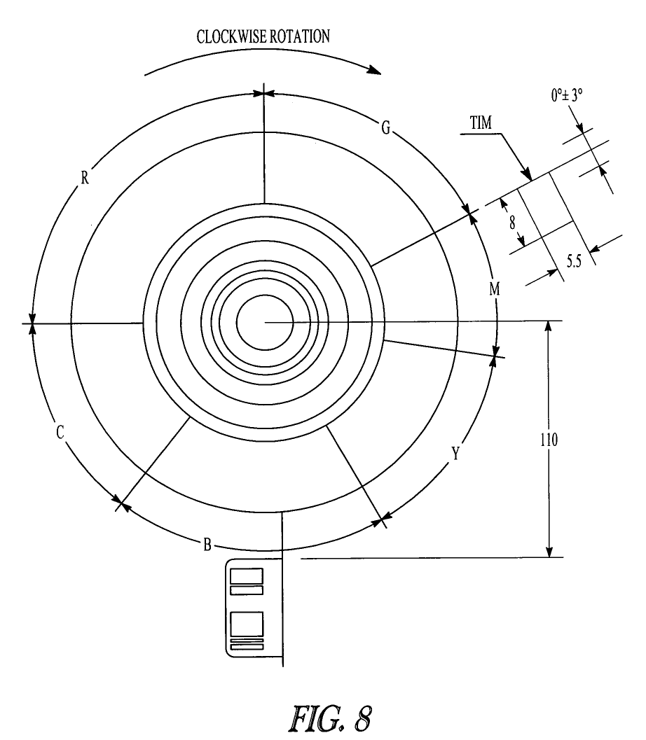

FIG. 8 shows an example RGBCYM wheel mechanical layout. As in the case of the RGBM wheel disclosed earlier, other layouts and ordering of the segments may be used in other embodiments.

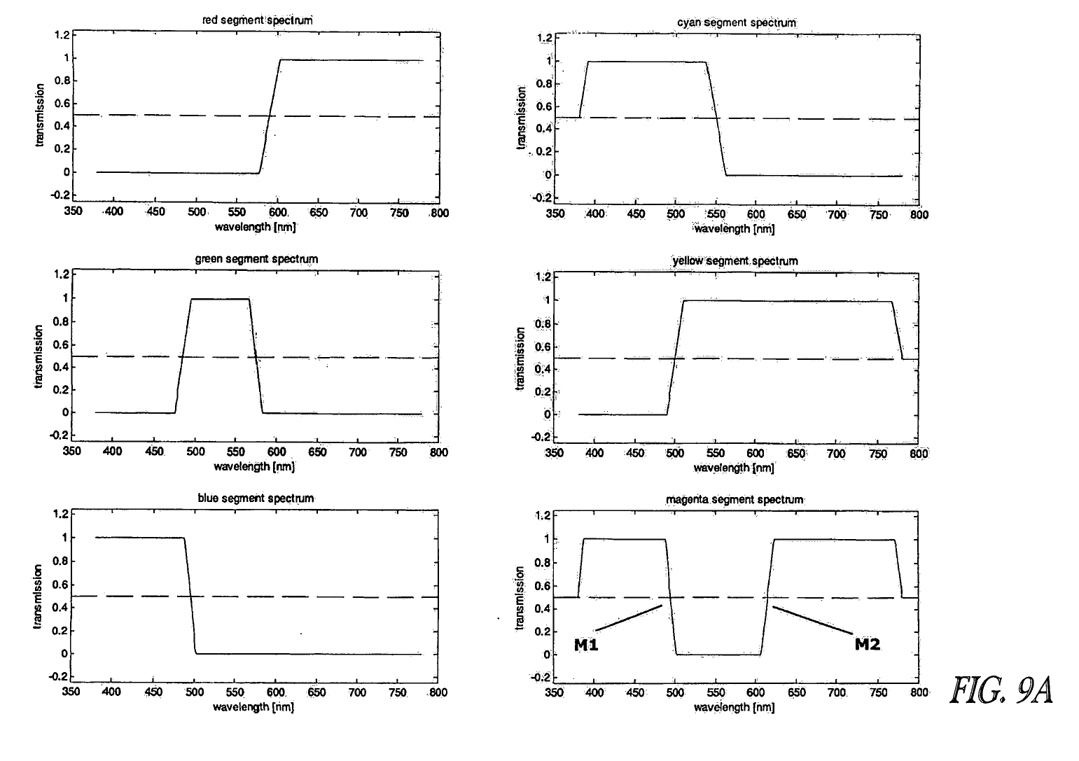

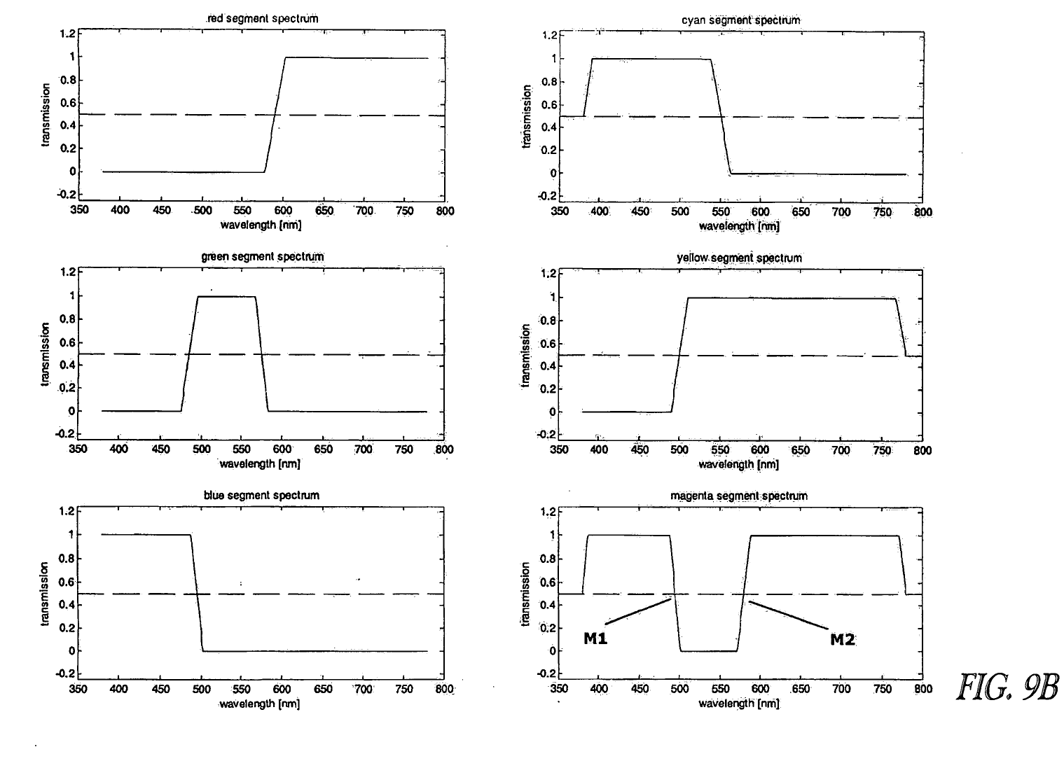

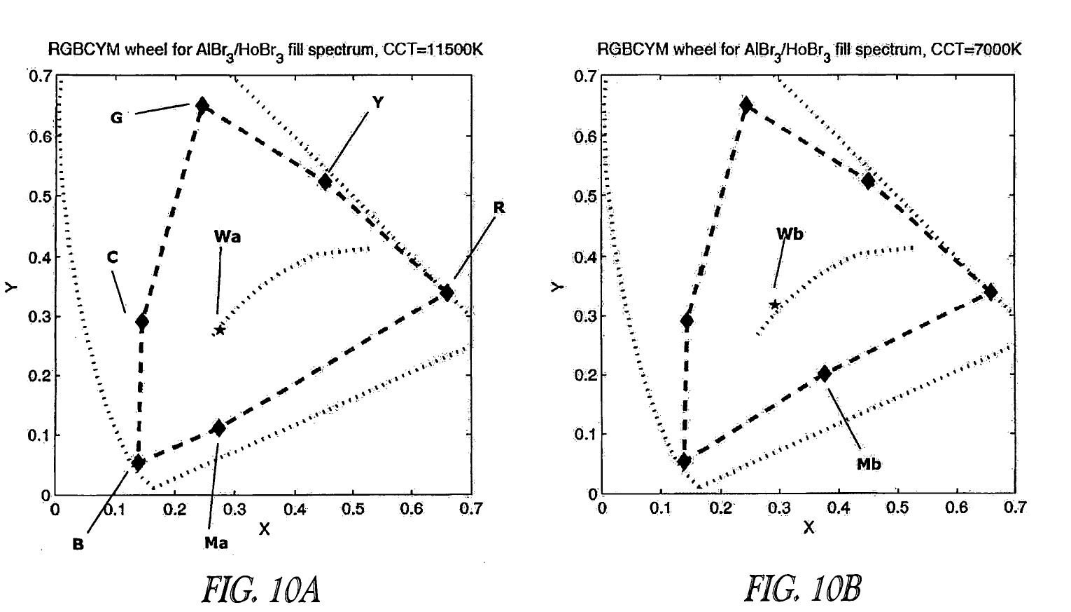

Two examples are described below for color balancing the spectrum of FIG. 7 to a color temperature of 11500K and 7000K, respectively. Both examples employ the methods of varying duty cycle and transmission spectra simultaneously. The transmission spectra of both designs differ only in the Magenta segment—the other segments' transmission spectra (and therefore their corresponding x/y coordinates) are the same. This is seen in FIG. 9 and FIG. 10. Other embodiments may change the transmission spectra of other color segments as well.

FIG. 9A shows the example 11500K wheel spectra. This example shows how color balancing at a high CCT (greater than or equal to about 10000K) may be achieved. The 50%-crossing points on the Magenta segment are at M1=495 nm and M2=615 nm in this example. The corresponding X/Y plot is shown in FIG. 10a, where it is seen that the system white point is well-balanced to the blackbody curve. The wheel duty cycles for this design are [T_{R}, T_{G}, T_{B}, T_{C}, T_{Y}, T_{M}]=[0.183 0.144 0.083 0.306 0.0720.211].

In other examples, an RGBCYM color wheel may be used to color balance at a CCT greater than or equal to 10000K. In these examples, the fill may be relatively balanced and include a metal halide that provides a relatively strong emission in or near the blue wavelengths and a metal halide that provides a relatively strong emission in or near the red wavelengths. In example embodiments, the 50% transmission points of a magenta color filter segment are, at the low end, in the range of about 485 nm to 510 nm or any range subsumed therein and, at the high end, in the range of about 580 nm to 625 nm or any range subsumed therein. In example embodiments, the duty cycle for red is in the range of about 0.15 to 0.2 or any range subsumed therein, the duty cycle for green is in the range of about 0.1 to 0.2 or any range subsumed therein, the duty cycle for blue is in the range of about 0.06 to 0.12 or any range subsumed therein, the duty cycle for cyan is in the range of about 0.25 to 0.35 or any range subsumed therein, the duty cycle for yellow is in the range of about 0.6 to 0.12 or any range subsumed therein and the duty cycle for magenta is in the range of about 0.15 to 0.25 or any range subsumed therein. These are examples only and other 50% transmission points and duty cycles may be used in other embodiments.

FIG. 9b shows the example 7000K wheel spectra. The 50%-crossing points on the Magenta segment are at M1=495 nm and M2=580 nm. The corresponding X/Y plot is shown in FIG. 10B, where it is again seen that the system white point is well-balanced to the blackbody curve. As expected, the Magenta segment vertex at Mb is shifted with respect to the Magenta segment vertex Ma of the wheel design shown in FIG. 10A, causing the reduction in system white point color temperature. The wheel duty cycles for this design are [T_{R}, T_{G}, T_{B}, T_{C}, T_{Y}, T_{M}]=[0.231 0.144 0.164 0.200 0.072 0.189].

In other examples, an RGBCYM color wheel may be used to color balance at a CCT in the range of about 6000-10000K or any range subsumed therein. In these examples, the fill may be relatively balanced and include a metal halide that provides a relatively strong emission in or near the blue wavelengths and a metal halide that provides a relatively strong emission in or near the red wavelengths. In example embodiments, the 50% transmission points of a magenta color filter segment are, at the low end, in the range of about 470 nm to 510 nm or any range subsumed therein and, at the high end, in the range of about 550 nm to 610 nm or any range subsumed therein. In example embodiments, the duty cycle for red is in the range of about 0.15 to 0.3 or any range subsumed therein, the duty cycle for green is in the range of about 0.1 to 0.2 or any range subsumed therein, the duty cycle for blue is in the range of about 0.1 to 0.2 or any range subsumed therein, the duty cycle for cyan is in the range of about 0.15 to 0.3 or any range subsumed therein, the duty cycle for yellow is in the range of about 0.6 to 0.12 or any range subsumed therein and the duty cycle for magenta is in the range of about 0.15 to 0.25 or any range subsumed therein. These are examples only and other 50% transmission points and duty cycles may be used in other embodiments.

An example lamp and fills will now be described. Other embodiments may use other lamps and fills. In example embodiments, the fill may include metal halide, such as Indium Halide, Aluminum Halide and/or Holmium Halide. Some embodiments may also use Mercury and a noble gas in the fill. Other embodiments may be Mercury free.

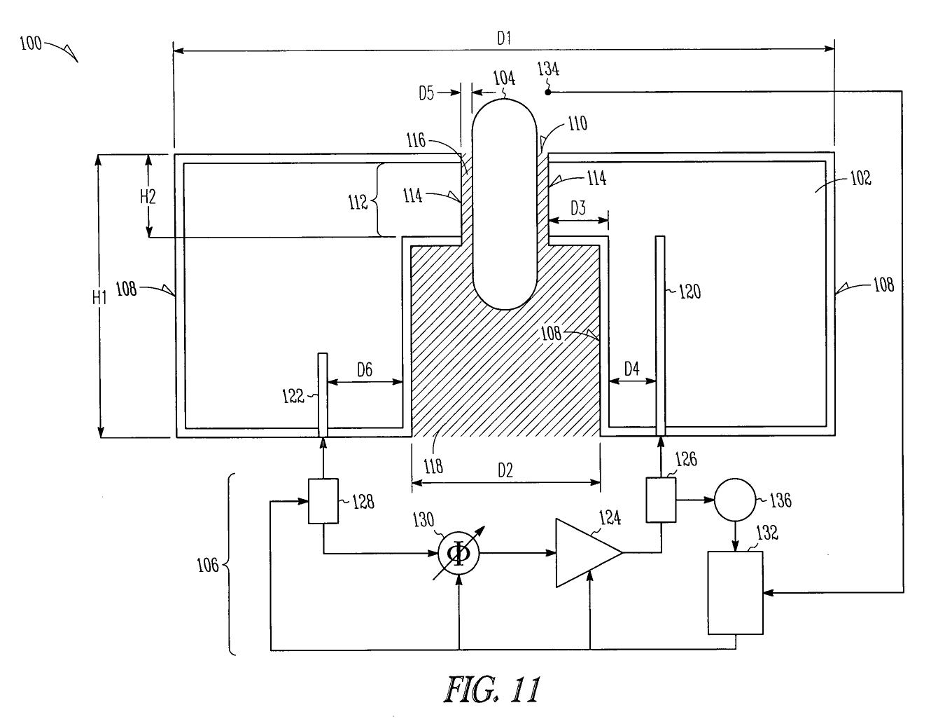

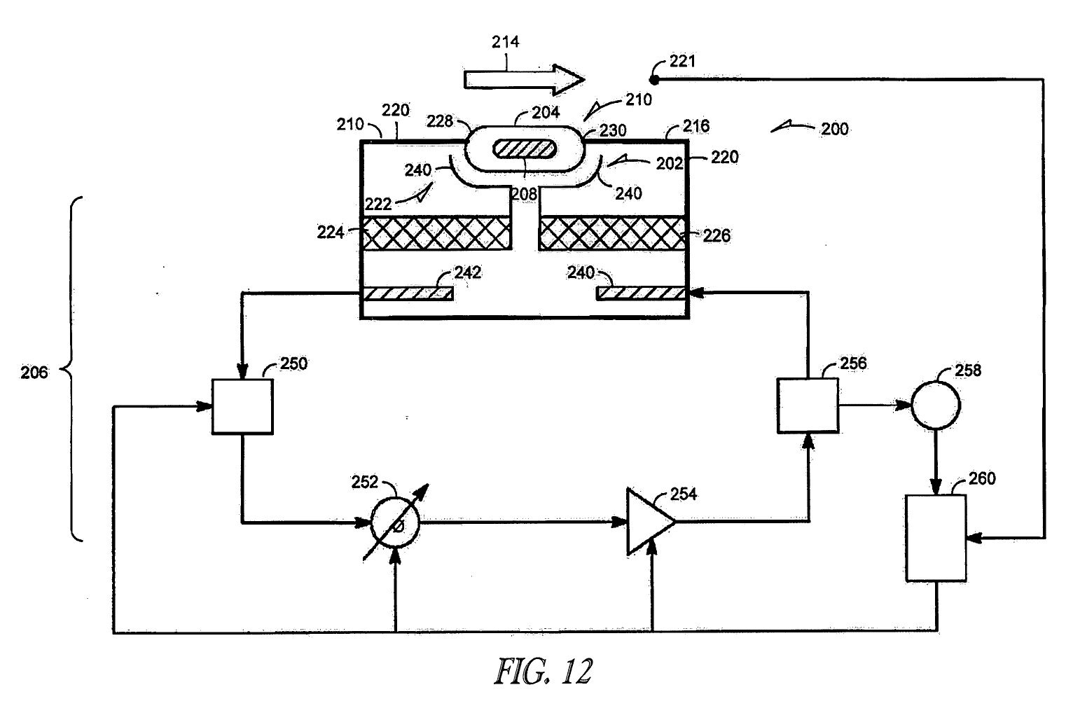

In example embodiments, these fills are used in an electrodeless plasma lamp. FIG. 11 is a cross-section and schematic view of an example electrodeless plasma lamp 100 that may be used in connection with an example embodiment. This is an example only and other plasma lamps may be used with other embodiments (see for example FIG. 12), including microwave or inductive plasma lamps. In the example of FIG. 11, the plasma lamp may have a lamp body 102 formed from one or more solid dielectric materials and a bulb 104 positioned adjacent to the lamp body 102. The bulb 104 contains a fill that is capable of forming a light emitting plasma. A lamp drive circuit 106 couples radio frequency power into the lamp body 102 which, in turn, is coupled into the fill in the bulb 104 to form the light emitting plasma. In example embodiments, the lamp body 102 forms a waveguide that contains and guides the radio frequency power. In example embodiments, the radio frequency power may be provided at or near a frequency that resonates within the lamp body 102. This is an example only and some embodiments may use a different electrodeless plasma lamp, such as a capacitively or inductively coupled plasma lamp, or other high intensity discharge lamp.

Lamp 100 has a drive probe 120 inserted into the lamp body 102 to provide radio frequency power to the lamp body 102. In the example of FIG. 11, the lamp also has a feedback probe 122 inserted into the lamp body 102 to sample power from the lamp body 102 and provide it as feedback to the lamp drive circuit 106. A lamp drive circuit 106 including a power supply, such as amplifier 124, may be coupled to the drive probe 120 to provide the radio frequency power. The amplifier 124 may be coupled to the drive probe 120 through a matching network 126 to provide impedance matching. In an example embodiment, the lamp drive circuit 106 is matched to the load (formed by the lamp body, bulb and plasma) for the steady state operating conditions of the lamp. The lamp drive circuit 106 is matched to the load at the drive probe 120 using the matching network 126.

In example embodiments, radio frequency power may be provided at a frequency in the range of between about 0.1 GHz and about 10 GHz or any range subsumed therein. The radio frequency power may be provided to drive probe 120 at or near a resonant frequency for lamp body 102. The frequency may be selected based on the dimensions, shape and relative permittivity of the lamp body 102 to provide resonance in the lamp body 102. In example embodiments, the frequency is selected for a fundamental resonant mode of the lamp body 102, although higher order modes may also be used in some embodiments. In example embodiments, the RF power may be applied at a resonant frequency or in a range of from 0% to 10% above or below the resonant frequency or any range subsumed therein. In some embodiments, RF power may be applied in a range of from 0% to 5% above or below the resonant frequency. In some embodiments, power may be provided at one or more frequencies within the range of about 0 to 50 MHz above or below the resonant frequency or any range subsumed therein. In another example, the power may be provided at one or more frequencies within the resonant bandwidth for at least one resonant mode. The resonant bandwidth is the full frequency width at half maximum of power on either side of the resonant frequency (on a plot of frequency versus power for the resonant cavity).

In example embodiments, the radio frequency power causes a light emitting plasma discharge in the bulb. In example embodiments, power is provided by RF wave coupling. In example embodiments, RF power is coupled at a frequency that forms a standing wave in the lamp body (sometimes referred to as a sustained waveform discharge or microwave discharge when using microwave frequencies). In other example embodiments, a capacitively coupled or inductively coupled electrodeless plasma lamp may be used. Other high intensity discharge lamps may be used in other embodiments.

The bulb 104 may be quartz, sapphire, ceramic or other desired bulb material and may be cylindrical, pill shaped, spherical or other desired shape. In an example embodiment, the bulb is cylindrical in the center and forms a hemisphere at each end. In one example, the outer length (from tip to tip) is about 15 mm and the outer diameter (at the center) is about 5 mm. In this example, the interior of the bulb (which contains the fill) has an interior length of about 9 mm and an interior diameter at the center of about 2 mm. The wall thickness is about 1.5 mm along the sides of the cylindrical portion. The wall thickness at the front end is about 2.25 mm. In this example, the interior bulb volume is about 26.18 mm³. The wall thickness at the other end is about 3.75 mm. In other example embodiments, the bulb may have an interior width or diameter in a range between about 2 and 30 mm or any range subsumed therein, a wall thickness in a range between about 0.5 and 4 mm or any range subsumed therein, and an interior length between about 2 and 30 mm or any range subsumed therein. In example embodiments, the interior bulb volume may range from 10 mm³ and 750 mm³ or any range subsumed therein. These dimensions are examples only and other embodiments may use bulbs having different dimensions.

In example embodiments, the bulb 104 contains a fill that forms a light emitting plasma when radio frequency power is received from the lamp body 102. The fill may include Aluminum Halide and/or Holmium Halide. In example embodiments, the dose amount of Aluminum Halide is in the range of from about from 1 to 50 micrograms per cubic millimeter of bulb volume, or any range subsumed therein. In example embodiments, the dose amount of Holium Halide is in the range of from about from 1 to 50 micrograms per cubic millimeter of bulb volume, or any range subsumed therein. In some embodiments, the dose of Aluminum Halide and the dose of Holmium Halide are each in the range of from about 10 to 10,000 micrograms or any range subsumed therein. In example embodiments, these dose amount result in a condensed pool of metal halide during lamp operation. A noble gas and additives such as Mercury may also be used. In example embodiments, the dose amount of Mercury is in the range of 10 to 100 micrograms of Mercury per mm³ of bulb volume, or any range subsumed therein. In some embodiments, the dose of Mercury may be in the range of from about 0.5 to 5 milligrams or any range subsumed therein. An ignition enhancer may also be used. A small amount of an inert radioactive emitter such as Kr85 may be used for this purpose. In some examples, Kr85 may be provided in the range of about 5 nanoCurie to 1 microCurie or any range subsumed therein.

In a particular example embodiment, the fill includes Aluminum Iodide or Aluminum Bromide in the range from about 0.05 mg to 0.3 mg or any range subsumed therein, and Holmium Iodide or Holmium Bromide in the range from about 0.05 mg to 0.3 mg or any range subsumed therein. Aluminum Chlorides and Holmium Chlorides may also be used in some embodiments. In some embodiments, Aluminum Halide and Holmium Halide are provided in equal amounts. In other embodiments, the ratio of Aluminum Halide to Holmium Halide may be 10:90, 20:80, 30:70, 40:60, 60:40, 70:30, 80:20 or 90:10. Other metal halides may also be used in other embodiments in addition to Aluminum Halide and/or Holmium Halide, including Bromides, Iodides and Chlorides of Indium, Aluminum, Gallium, Thalium, Holmium, Dysprosium, Cerium, Cesium, Erbium, Thulium, Lutetium and Gadolinium. Other metal halides may also be used in other embodiments, including Bromides, Iodides and Chlorides of Sodium, Calcium, Strontium, Yttrium, Tin, Antimony, Thorium and any of the elements in the Lanthanide series.

Some embodiments may use a combination of metal halides to produce a desired spectrum. In some examples, one or more metal halides with strong emission in the blue color range (such as halides of Aluminum, Cesium, Gallium, Indium and/or Scandium) may be combined with one or more metal halides to enhance emission in the red color range (such as halides of Sodium, Calcium, Strontium, Gadolinium, Dysprosium, Holmium, Erbium and/or Thulium). In particular example embodiments, the fill may include (1) Aluminum Halide and Holmium Halide; (2) Aluminum Halide and Erbium Halide; (3) Gallium Halide and Holmium Halide; (4) Gallium Halide and Erbium Halide; (5) any of these fill further including Indium Halide; (6) any of these fills further including an alkali metal halide such as Sodium Halide or Cesium Halide (although other examples may specifically exclude all alkali metals); and (7) any of these fills further including Cerium Halide.

In some example embodiments, the example fills described in the preceding paragraph may be used in a projection display system with an RGBCYM color wheel of the type described above. In example embodiments, the color wheel uses 50% transmission points for magenta and duty cycles within any of the ranges described above to color balance at a CCT in the range of about 6000 to 11500 K or any range subsumed therein.

In other example embodiments, any of the above fills that are strong in the blue or green ranges (including halides of Aluminum, Cesium, Gallium, Indium and/or Scandium) or other fills may be used in a projection display system with an RGBM color wheel of the type described above. In example embodiments, the color wheel uses 50% transmission points for magenta and duty cycles within any of the ranges described above to color balance at a CCT in the range of about 6000 to 11500 K or any range subsumed therein.

Example metal halide and Mercury fills include, but are not limited to, the fills described in Table 1 below.

TABLE 1

| Fill | InBr | DyI₃ | CeI₃ | HoBr₃ | AlBr₃ | ErBr₃ | GdI₃ | HoI₃ | Hg |
|---|---|---|---|---|---|---|---|---|---|
| #1 | 0.1 mg | 0.1 mg | 0 | 0 | 0 | 0 | 0 | 0 | 2.7 mg |
| #2 | 0.1 mg | 0 | 0.1 mg | 0 | 0 | 0 | 0 | 0 | 2.7 mg |
| #3 | 0 | 0 | 0 | 0.05 mg | 0.05 mg | 0 | 0 | 0 | 1.35 mg |
| #4 | 0.1 mg | 0 | 0 | 0 | 0.1 mg | 0 | 0 | 0 | 2.7 mg |
| #5 | 0.1 mg | 0 | 0 | 0 | 0 | 0 | 0.1 mg | 0 | 2.7 mg |
| #6 | 0.1 mg | 0 | 0 | 0 | 0 | 0 | 0 | 0.1 mg | 2.7 mg |
| #7 | 0.1 mg | 0 | 0 | 0 | 0 | 0 | 0 | 0 | 1.6 mg |
| #8 | 0 | 0 | 0 | 0 | 0.05 mg | 0.05 mg | 0 | 0 | 1.35 mg |

In an example embodiment, the metal halide(s) may be provided in the range from about 0.01 mg to 10 mg or any range subsumed therein and Mercury may be provided in the range of about 0.01 to 10 mg or any range subsumed therein. In example embodiments, the fill includes 1 to 100 micrograms of metal halide per mm³ of bulb volume, or any range subsumed therein, 1 to 100 micrograms of Mercury per mm³ of bulb volume, or any range subsumed therein, and 5 nanoCurie to 1 microCurie of a radioactive ignition enhancer, or any range subsumed therein. In other examples, the fill may include a dose of one or more metal halides in the range of about 1 to 100 micrograms of metal halide per mm³ of bulb volume without Mercury. In some embodiments using more than one metal halide, the total dose may be in any of the above ranges and the percentage of each metal halide may range from 5% to 95% of the total dose. In example embodiments, fills including any of the above metal halides may be used in a projection display system with an RGBM color wheel of the type described above or an RGBCYM color wheel of the type described above.

In example embodiments, a high pressure fill is used to increase the resistance of the gas. This can be used to decrease the overall startup time required to reach full brightness for steady state operation. In one example, a noble gas such as Helium, Neon, Argon, Krypton or Xenon, or another substantially non-reactive gas such as Nitrogen, or a combination of these gases is provided at high pressures between 200 Torr to 3000 Torr or any range subsumed therein. Pressures less than or equal to 760 Torr may be desired in some embodiments to facilitate filling the bulb at or below atmospheric pressure. In particular embodiments, pressures between 400 Torr and 600 Torr are used to enhance starting. Example high pressure fills may also include Aluminum Halide, Holmium Halide and Mercury which have a relatively low vapor pressure at room temperature. An ignition enhancer such as Kr85 may also be used. The above pressures are measured at 22° C. (room temperature). It is understood that much higher pressures are achieved at operating temperatures after the plasma is formed. For example, the lamp may provide a high intensity discharge at high pressure during operation (e.g., greater than 2 atmospheres and 10-30 atmospheres or more in example embodiments or any range subsumed therein).

In example embodiments, the bulb is provided with a fill including Aluminum Halide, Holmium Halide and Mercury in amounts selected to provide 15,000 to 20,000 lumens (or any range subsumed therein) at a correlated color temperature of 4000 to 10000 K (or any range subsumed therein) with a bulb geometry enabling the collection of 4500 to 5500 lumens (or any range subsumed therein) in 27 mm² steradian when operated at 150 to 200 watts (or any range subsumed therein). In some embodiments, the fill may be selected to provide a correlated color temperature in the range of 6000 to 9000 K. These doses, pressures and fills are examples only and other doses, pressures and fills may be used in other embodiments.

The lamp of FIG. 11 will now be described in further detail. As shown in FIG. 11, the amplifier 124 may be coupled to the drive probe 120 through a matching network 126 to provide impedance matching. In an example embodiment, the amplifier 124 is matched to about 50 ohms for the steady state operating conditions of the lamp.

In example embodiments, the amplifier 124 may be operated in multiple operating modes at different bias conditions to improve starting and then to improve overall amplifier efficiency during steady state operation. For example, the amplifier may be biased to operate in Class A/B mode to provide better dynamic range during startup and in Class C mode during steady state operation to provide more efficiency. The amplifier may also have a gain control that can be used to adjust the gain of the amplifier 124. Amplifier 124 may include either a plurality of gain stages or a single stage.

The feedback probe 122 is coupled to the input of the amplifier 124 through an attenuator 128 and phase shifter 130. The attenuator 128 is used to adjust the power of the feedback signal to an appropriate level for input to the phase shifter 130. In some embodiments, a second attenuator may be used between the phase shifter 130 and the amplifier 124 to adjust the power of the signal to an appropriate level for amplification by the amplifier 124. In some embodiments, the attenuator(s) may be variable attenuators controlled by the control electronics 132. In other embodiments, the attenuators may be set to a fixed value. In some embodiments, the lamp drive circuit may not include an attenuator. In an example embodiment, the phase shifter 130 may be a voltage-controlled phase shifter controlled by the control electronics 132.

The feedback loop automatically oscillates at a frequency based on the load conditions and phase of the feedback signal. This feedback loop may be used to maintain a resonant condition in the lamp body 102 even though the load conditions change as the plasma is ignited and the temperature of the lamp changes. If the phase is such that constructive interference occurs for waves of a particular frequency circulating through the loop, and if the total response of the loop (including the amplifier, lamp, and all connecting elements) at that frequency is such that the wave is amplified rather than attenuated after traversing the loop, the loop will oscillate at that frequency. Whether a particular setting of the phase-shifter induces constructive or destructive feedback depends on frequency. The phase-shifter 128 can be used to finely tune the frequency of oscillation within the range supported by the lamp's frequency response. In doing so, it also effectively tunes how well RF power is coupled into the lamp because power absorption is frequency-dependent. Thus, the phase-shifter 128 provides fast, finely-tunable control of the lamp output intensity. Both tuning and detuning are useful. For example: tuning can be used to maximize intensity as component aging changes the overall loop phase; detuning can be used to control lamp dimming. In some example embodiments, the phase selected for steady state operation may be slightly out of resonance, so maximum brightness is not achieved. This may be used to leave room for the brightness to be increased and/or decreased by control electronics 130.

In FIG. 11, control electronics 132 is connected to attenuator 128, phase shifter 130 and amplifier 124. The control electronics 132 may also be connected to line 76 (shown in FIG. 1A) to receive input from the system control electronics 70 (shown in FIG. 1A). The control electronics 132 provide signals to adjust the level of attenuation provided by the attenuator 128, phase of phase shifter 130, the class in which the amplifier 124 operates (e.g., Class A/B, Class B or Class C mode) and/or the gain of the amplifier 124 to control the power provided to the lamp body 102. In one example, the amplifier 124 has three stages, a pre-driver stage, a driver stage and an output stage, and the control electronics 132 provides a separate signal to each stage (drain voltage for the pre-driver stage and gate bias voltage of the driver stage and the output stage). The drain voltage of the pre-driver stage can be adjusted to adjust the gain of the amplifier. The gate bias of the driver stage can be used to turn on or turn off the amplifier. The gate bias of the output stage can be used to chose the operating mode of the amplifier (e.g., Class A/B, Class B or Class C). Control electronics 130 can range from a simple analog feedback circuit to a microprocessor/microcontroller with embedded software or firmware that controls the operation of the lamp drive circuit. The control electronics 130 may include a lookup table or other memory that contains control parameters (e.g., amount of phase shift or amplifier gain) to be used when certain operating conditions are detected. In example embodiments, feedback information regarding the lamp's light output intensity is provided either directly by an optical sensor 134, e.g., a silicon photodiode sensitive in the visible wavelengths, or indirectly by an RF power sensor 136, e.g., a rectifier. The RF power sensor 136 may be used to determine forward power, reflected power or net power at the drive probe 120 to determine the operating status of the lamp. A directional coupler may be used to tap a small portion of the power and feed it to the RF power sensor 136. An RF power sensor may also be coupled to the lamp drive circuit at the feedback probe 122 to detect transmitted power for this purpose. In some embodiments, the control electronics 132 may adjust the phase shifter 130 on an ongoing basis to automatically maintain desired operating conditions.

The phase of the phase shifter 130 and/or gain of the amplifier 124 may also be adjusted after startup to change the operating conditions of the lamp. For example, the power input to the plasma in the bulb 104 may be modulated to modulate the intensity of light emitted by the plasma. This can be used for brightness adjustment or to modulate the light to adjust for video effects in a projection display. For example, a projection display system may use a microdisplay that controls intensity of the projected image using pulse-width modulation (PWM). PWM achieves proportional modulation of the intensity of any particular pixel by controlling, for each displayed frame, the fraction of time spent in either the “ON” or “OFF” state. By reducing the brightness of the lamp during dark frames of video, a larger range of PWM values may be used to distinguish shades within the frame of video. The brightness of the lamp may also be modulated during particular color segments of a color wheel for color balancing or to compensate for green snow effect in dark scenes by reducing the brightness of the lamp during the green segment of the color wheel. The system control electronics 70 (shown in FIG. 1A) may provide signals via line 76 (shown in FIG. 1A) to control the operating mode and brightness of the lamp in example embodiments.

In another example, the phase shifter 130 can be modulated to spread the power provided by the lamp circuit 106 over a larger bandwidth. This can reduce ElectroMagnetic Interference (EMI) at any one frequency and thereby help with compliance with FCC regulations regarding EMI. In example embodiments, the degree of spectral spreading may be from 5-30% or any range subsumed therein. In one example, the control electronics 132 may include circuitry to generate a sawtooth voltage signal and sum it with the control voltage signal to be applied to the phase shifter 130. In another example, the control electronics 132 may include a microcontroller that generates a Pulse Width Modulated (PWM) signal that is passed through an external low-pass filter to generate a modulated control voltage signal to be applied to the phase shifter 130. In example embodiments, the modulation of the phase shifter 130 can be provided at a level that is effective in reducing EMI without any significant impact on the plasma in the bulb.

Additional aspects of electrodeless plasma lamps according to example embodiments will now be described with reference to FIG. 11. In example embodiments, the lamp body 102 has a relative permittivity greater than air. The frequency required to excite a particular resonant mode in the lamp body 102 generally scales inversely to the square root of the relative permittivity (also referred to as the dielectric constant) of the lamp body. As a result, a higher relative permittivity results in a smaller lamp body required for a particular resonant mode at a given frequency of power. The shape and dimensions of the lamp body 102 also affect the resonant frequency as described further below. In an example embodiment, the lamp body 102 is formed from solid alumina having a relative permittivity of about 9.2. In some embodiments, the dielectric material may have a relative permittivity in the range of from 2 to 100 or any range subsumed therein, or an even higher relative permittivity. In some embodiments, the body may include more than one such dielectric material resulting in an effective relative permittivity for the body within any of the ranges described above. The body may be rectangular, cylindrical or other shape as described further below.

In example embodiments, the outer surfaces of the lamp body 102 may be coated with an electrically conductive coating 108, such as electroplating or a silver paint or other metallic paint which may be fired onto the outer surface of the lamp body. The electrically conductive material 108 may be grounded to form a boundary condition for the radio frequency power applied to the lamp body 102. The electrically conductive coating helps contain the radio frequency power in the lamp body. Regions of the lamp body may remain uncoated to allow power to be transferred to or from the lamp body. For example, the bulb 104 may be positioned adjacent to an uncoated portion of the lamp body to receive radio frequency power from the lamp body.

In the example embodiment of FIG. 11, an opening 110 extends through a thin region 112 of the lamp body 102. The surfaces 114 of the lamp body 102 in the opening 110 are uncoated and at least a portion of the bulb 104 may be positioned in the opening 110 to receive power from the lamp body 102. In example embodiments, the thickness H2 of the thin region 112 may range from 1 mm to 10 mm or any range subsumed therein and may be less than the outside length and/or interior length of the bulb. One or both ends of the bulb 104 may protrude from the opening 110 and extend beyond the electrically conductive coating 108 on the outer surface of the lamp body. This helps avoid damage to the ends of the bulbs from the high intensity plasma formed adjacent to the region where power is coupled from the lamp body. In other embodiments, all or a portion of the bulb may be positioned in a cavity extending from an opening on the outer surface of the lamp body and terminating in the lamp body. In other embodiments, the bulb may be positioned adjacent to an uncoated outer surface of the lamp body or in a shallow recess formed on the outer surface of the waveguide body. In some example embodiments, the bulb may be positioned at or near an electric field maxima for the resonant mode excited in the lamp body.

A layer of material 116 may be placed between the bulb 104 and the dielectric material of lamp body 102. In example embodiments, the layer of material 116 may have a lower thermal conductivity than the lamp body 102 and may be used to optimize thermal conductivity between the bulb 104 and the lamp body 102. In an example embodiment, the layer 116 may have a thermal conductivity in the range of about 0.5 to 10 watts/meter-Kelvin (W/mK) or any range subsumed therein. For example, alumina powder with 55% packing density (45% fractional porosity) and thermal conductivity in a range of about 1 to 2 watts/meter-Kelvin (W/mK) may be used. In some embodiments, a centrifuge may be used to pack the alumina powder with high density. In an example embodiment, a layer of alumina powder is used with a thickness D5 within the range of about ⅛ mm to 1 mm or any range subsumed therein. Alternatively, a thin layer of a ceramic-based adhesive or an admixture of such adhesives may be used. Depending on the formulation, a wide range of thermal conductivities is available. In practice, once a layer composition is selected having a thermal conductivity close to the desired value, fine-tuning may be accomplished by altering the layer thickness. Some example embodiments may not include a separate layer of material around the bulb and may provide a direct conductive path to the lamp body. Alternatively, the bulb may be separated from the lamp body by an air-gap (or other gas filled gap) or vacuum gap.

In some example embodiments, alumina powder or other material may also be packed into a recess 118 formed below the bulb 104. In the example shown in FIG. 11, the alumina powder in the recess 118 is outside the boundaries of the waveguide formed by the electrically conductive material 108 on the surfaces of the lamp body 102. The material in the recess 118 provides structural support, reflects light from the bulb and provides thermal conduction. One or more heat sinks may also be used around the sides and/or along the bottom surface of the lamp body to manage temperature. Thermal modeling may be used to help select a lamp configuration providing a high peak plasma temperature resulting in high brightness, while remaining below the working temperature of the bulb material. Example thermal modeling software includes the TAS software package available commercially from Harvard Thermal, Inc. of Harvard, Mass.

FIG. 12 is a cross-section and schematic view of a plasma lamp 200 that may be used as a light source in a projection system according to an example embodiment. It should be noted that the fills/color wheels and methodology described above are capable of use in combination with the plasma lamp 200. As in the case of the lamp 100, the plasma lamp 200 may have a lamp body 202 formed from one or more solid dielectric materials and a bulb 204 positioned adjacent to the lamp body 202. As described above, the bulb 204 contains a fill that is capable of forming a light emitting plasma. A lamp drive circuit 206 couples radio frequency (RF) power into the lamp body 202 which, in turn, is coupled into the fill in the bulb 204 to form the light emitting plasma. In example embodiments, the lamp body 202 forms a structure that contains and guides the radio frequency power.

Unlike the plasma lamp 100, in the plasma lamp 200 the bulb 204 is positioned or orientated so that a length of a plasma arc 208 generally faces a lamp opening 210 (as opposed to facing side walls 220) to increase an amount of collectable light emitted from the plasma arc in a given etendue. Since the length of plasma arc orients in a direction of an applied electric field, the lamp body 202 and the coupled RF power are configured to provide an electric field 214 that is aligned or substantially parallel to the length of the bulb 204 and a front or upper surface 216 of the lamp body 202. Thus, in an example embodiment, the length of the plasma arc 204 may be substantially (if not completely) visible from outside the lamp body 202. In example embodiments, collection optics (see for example FIG. 1A) may be in the line of sight of the full length of the bulb 204 and plasma arc 208. In other examples, about 40%-100%, or any range subsumed therein, of the plasma arc may be visible to the collection optics (see FIG. 1A) in front of the lamp 200. Accordingly, the amount of light emitted from the bulb 204 and received by the collection optics may be enhanced. In example embodiments, a substantial amount of light may be emitted out of the lamp 200 from the plasma arc through the opening 210 in the front side wall of the lamp 200 without any internal reflection. The lamp body 202 may be configured to realize the necessary resonator structure such that the light emission of the lamp 200 is enabled while satisfying Maxwell's equations.

The lamp body 202 may include a solid dielectric body and an electrically conductive coating which extends to the front or upper surface 216. The lamp 200 is also shown to include dipole arms 222 and conductive elements 224, 226 (e.g., metallized cylindrical holes bored into the body 202) to concentrate the electric field present in the lamp body 202. The dipole arms 222 may thus define an internal dipole. In an example embodiment, a resonant frequency applied to a lamp body 202 without dipole arms 222 and conductive elements 224, 226 would result in a high electric field at the center of the solid dielectric lamp body 202. This is based on the intrinsic resonant frequency response of the lamp body due to its shape, dimensions and relative permittivity. However, in the example embodiment of the lamp 200 shown in FIG. 12, the shape of the standing waveform inside the lamp body 202 is substantially modified by the presence of the dipole arms 222 and conductive elements 224, 226 and the electric field maxima is brought out to end portions 228, 230 of the bulb 204 using the internal dipole structure. This results in the electric field 214 near the upper surface 216 of the lamp 200 that is substantially parallel to the length of the bulb 204. In some example embodiments, this electric field is also substantially parallel to a drive probe 240 and a feedback probe 242.

The plasma lamp 200 may include an example lamp drive circuit 206. The circuit 206 is connected to the drive probe 240 inserted into the lamp body 202 to provide radio frequency power to the lamp body 202. In the example embodiment, the lamp 200 is also shown to include the feedback probe 242 inserted into the lamp body 202 to sample power from the lamp body 202 and provide it as feedback to the lamp drive circuit 206.

Various positions for the probes 240, 242 are possible. The physical principle governing their position is the degree of desired power coupling versus the strength of the E-field in the lamp body 202. For the drive probe 240, the desire is for strong power coupling. Therefore, the drive probe 240 may be located near a field maximum in some embodiments. For the feedback probe 242, the desire is for weak power coupling. Therefore, the feedback probe 242 may be located away from a field maximum in some embodiments.

The lamp drive circuit 206 is shown to include a power supply, such as amplifier 254, which may be coupled to the drive probe 240 to provide the radio frequency power. The amplifier 254 may be coupled to the drive probe 240 through a directional coupler 256 to provide impedance matching. The directional coupler 256 may be connected to control electronics 260 via an RF power sensor 258. In an example embodiment, the lamp drive circuit 206 is matched to the load (formed by the lamp body 202, the bulb 204 and the plasma) for the steady state operating conditions of the lamp 200.

The feedback probe 242 is shown to be coupled to an input of the amplifier 254 (which may resemble the amplifier 124) through an attenuator 250 and the phase shifter 252. The attenuator 250 is used to adjust the power of the feedback signal to an appropriate level for input to the phase shifter 252. In some example embodiments, a second attenuator may be used between the phase shifter 252 and the amplifier 254 to adjust the power of the signal to an appropriate level for amplification by the amplifier 254. In some embodiments, the attenuator(s) may be variable attenuators controlled by control electronics 260. In other embodiments, the attenuator(s) may be set to a fixed value. In some embodiments, the lamp drive circuit 206 may not include an attenuator. In an example embodiment, the phase shifter 252 may be a voltage-controlled phase shifter controlled by the control electronics 260. In example embodiments, feedback information regarding the lamp's light output intensity is provided either directly by the optical sensor 221, e.g., a silicon photodiode sensitive in the visible wavelengths, or indirectly by the RF power sensor, e.g., a rectifier.

In an example embodiment, the control electronics 260 may resemble the control electronics 132 and may also be connected to line 76 (shown in FIG. 1A) to receive input from the system control electronics 70 (shown in FIG. 1A). The control electronics 260 may provide signals to adjust the level of attenuation provided by the attenuator 250, phase of phase shifter 252, the class in which the amplifier 254 operates (e.g., Class A/B, Class B or Class C mode) and/or the gain of the amplifier 254 to control the power provided to the lamp body 202.

The above circuits, dimensions, shapes, materials and operating parameters are examples only and other embodiments may use different circuits, dimensions, shapes, materials and operating parameters.

What is claimed is:

1. A display system comprising:
a light source configured to emit a beam of white light along a first light path;
a color wheel on the first light path configured to filter the beam of white light, the color wheel having a plurality of color segments, including a red color segment, a blue color segment, a green color segment and a magenta color segment, wherein the magenta color segment is the only subtractive primary color segment and has a duty cycle of greater than 0.1; and
a light modulator configured to receive filtered light from the color wheel and modulate the received light to produce an image.

2. The display system of claim 1, wherein light source is configured to produce a spectrum having a peak in the green color band.

3. The display system of claim 1, wherein light source is an electrodeless plasma lamp, wherein the lamp has a bulb containing a fill that includes Indium Bromide.

4. The display system of claim 1, wherein the magenta color segment has an angle of at least 40 degrees on the color wheel.

5. The display system of claim 1, further comprising control electronics configured to pulse width modulate the light modulator.

6. The display system of claim 5, wherein the control electronics is configured to provide at least 256 levels of pulse width modulation for the magenta color segment.

7. The display system of claim 5, wherein the control electronics is configured to provide at least the same number of levels of pulse width modulation for the magenta color segment as for the green color segment.

8. A method for producing an image comprising:
emitting a beam of white light;
filtering the white light using a color wheel, the color wheel having a plurality of color segments, including a red color segment, a blue color segment, a green color segment and a magenta color segment, wherein the magenta color segment is the only subtractive primary color segment and comprises at least 40 degrees on the color wheel; and
modulating the filtered light from the color wheel to produce an image.

9. A display system comprising:
a light source configured to emit a beam of white light along a first light path;
a color wheel on the first light path configured to filter the beam of white light, the color wheel having a plurality of color segments, including a red color segment, a blue color segment, a green color segment and a magenta color segment;
wherein the magenta color segment is the only subtractive primary color segment, has a duty cycle of greater than 0.1, and has an upper 50% transmission point greater than about 600 nm; and
a light modulator configured to receive filtered light from the color wheel and modulate the received light to produce an image.

10. The display system of claim 1, wherein the filtered light is color balanced at a CCT of 10000 K or more.

11. A display system comprising:
a light source configured to emit a beam of white light along a first light path, the light source having a bulb containing a fill, wherein the fill includes at least one metal halide selected from the group consisting of Aluminum Halide, Cesium Halide, Gallium Halide, Indium Halide and Scandium Halide and at least one metal halide selected from the group consisting of Sodium Halide, Calcium Halide, Strontium Halide, Gadolinium Halide, Dysprosium Halide, Holmium, Erbium Halide and Thulium Halide;
a color wheel on the first light path configured to filter the beam of white light, the color wheel having a plurality of color segments, including a red color segment, a blue color segment, a green color segment, a magenta color segment, a cyan color segment and a yellow color segment, wherein the red color segment, the cyan color segment and the magenta color segment are each larger than the yellow color segment, the green color segment and the blue color segment; and
a light modulator configured to receive filtered light from the color wheel and modulate the received light to produce an image.
